(19) United States
(12) Patent Application Publication
(10) Pub. No.: US 2018/0322495 A1
(43) Pub. Date: Nov. 8, 2018

(54) COMPUTER-IMPLEMENTED BANKING SYSTEM AND METHOD FOR THE VISUALLY-CHALLENGED

(71) Applicants: Ramin Farjad, Tehran (IR); Saeed Sadeghpour Vajdi, Tehran (IR); Arman Bahri, Tehran (IR)

(72) Inventors: Ramin Farjad, Tehran (IR); Saeed Sadeghpour Vajdi, Tehran (IR); Arman Bahri, Tehran (IR)

(21) Appl. No.: 15/871,061

(22) Filed: Jan. 15, 2018

(30) Foreign Application Priority Data
May 2, 2017 (IR) 13965014000300154

(51) Int. Cl. G06Q 20/40; G09B 21/00

(52) U.S. Cl. CPC G06Q 20/405; G09B 21/006; G09B 21/003

(57) ABSTRACT

Disclosed is a computer-implemented banking system for the visually-challenged. The system comprises a user terminal comprising an output means for perceivably-delivering to a user, a user-selected form from a plurality of banking forms, the form delivered one query at a time and an input means for receiving user input as a response to each query. The system further comprises a preview module for perceivably-delivering the user-inputted form, via the output means, to the user for preview and an authentication module for receiving the user's authentication upon the user finalizing the previewed form, wherein the authentication is associated with the form.

### BACKGROUND OF THE INVENTION

The visually-challenged/impaired customers make up a sizable demographic that avail banking services. However, many banks are not adequately sensitive to the special needs of such customers. For instance, the banks have never addressed to negate the need for the visually-challenged to rely on human assistance especially with reference to performing an everyday, commonplace banking activity like form filling. This is despite bank personnel (such as bank tellers) not being duty-bound to assist said customers. In the light of the aforementioned prior art not being adequate in satisfying the needs of the visually challenged, there is a need in the art to provide a solution for the visually-challenged enabling them to perform simple banking services without human assistance.

### SUMMARY OF THE INVENTION

An embodiment of the present invention is directed to a computer-implemented system for enabling the visually-challenged to perform banking operations without human assistance. More particularly, said banking operations include filling out banking forms (which include various application forms and contracts), authenticating the filled out forms and delivering the authenticated forms to a bank teller for subsequent processing thereof.

The system of the present invention comprises a remote server and various user terminals disposed in operative communication with the server over a communications network. A user terminal, about which a visually-challenged user interacts with the server, comprises a two or more client devices that are grouped together so as to work in tandem with one another. The client devices, more particularly, comprises a communication and an authentication device. A communication device comprise an electronic refreshable braille display, while the authentication device comprises a fingerprint scanner. The system further includes at least one memory for storing instructions, which are executed by at least one processor.

The system further comprises a database comprising a plurality of banking forms stored therewithin. The system further comprises a plurality of processing modules comprising a menu module, a preview module, an authentication module and a teller module wherein, each of said modules will become apparent from the following body of text.

The menu module is configured to deliver a menu to the braille display, where the user is made aware of the forms he/she is entitled to access. More particularly, the titles of the forms are delivered to the braille display in order for them to be read by the user. Upon reading, the user, via the braille keyboard, is enabled to select a form from the menu. In response to the user-selection of a form, the selected form is delivered to the braille display, one query at a time. For example, a query may comprise a query soliciting the bank account number of the user. In response to the query, the user, via the braille keyboard, is enabled to input a response to each query. A next query is delivered to the braille display upon the completion of the user-input to the preceding query.

The preview module is configured to deliver the completed form to the braille display one query and the corresponding input at a time. The authentication module, upon receiving an indication (via the braille keyboard) indicating user satisfaction with the completed form, is configured to receive an authentication from the user in the form of a user's fingerprint via the fingerprint scanner, at which point the form is deemed authentic. The authentic form is finally delivered in a perceivable format to a bank teller. In one embodiment, the present system is not connected to the official banking system and therefore is immune from potential hacking or other unauthorized access to the official banking system via the system.

One aspect of the present disclosure is directed to a computer-implemented banking system for the visually-challenged, the system comprising: (a) a user terminal comprising: an output means for perceivably-delivering to a user, a user-selected form from a plurality of banking forms, the form delivered one query at a time; and an input means for receiving user input as a response to each query; (b) a preview module for perceivably-delivering the user-inputted form to the output means for preview; and (c) an authentication module for receiving the user's authentication upon the user finalizing the previewed form, the authentication associated with the form.

In one embodiment, the user terminal comprises an electronic refreshable braille display and wherein, the input and output means comprise a plurality of dynamic braille cells and a braille keyboard respectively. In another embodiment, the user-inputted form is delivered to the braille display for preview. In one embodiment, the system further comprises a teller module for converting the authenticated form in braille to text; the converted form delivered to a bank teller for the processing thereof. In one embodiment, the user terminal comprises a headset with microphone and wherein, the input and output means comprise at least one speaker for voice-delivering the user-selected form one query at a time and a microphone for receiving the user's voice as input as a response to each query.

In one embodiment, the user-inputted form is voice-delivered from the at least one speaker for preview. In another embodiment, the system further comprises a teller module for delivering the authenticated form to a bank teller for the processing thereof. In another embodiment, the system further comprises a database comprising the plurality of forms stored therewithin; a form selected by the user from the database via the user terminal. In one embodiment, the authentication module comprises a fingerprint scanner and wherein the authentication comprises a fingerprint of the user.

Another aspect of the present disclosure is directed to a computer-implemented method for assisting the visually-challenged in banking operations, the method comprising the steps of: (a) perceivably-delivering to a user, via an output means, a user-selected form from a plurality of banking forms, the form delivered one query at a time; (b) receiving user input, via an input means, in response to each query; (c) perceivably-delivering the user-inputted form, via the output means, to the user for preview; and (d) receiving the user's authentication upon finalization.

In a related embodiment, the input and output means comprise a plurality of refreshable braille cells and a braille keyboard respectively. In one embodiment, the method further comprises delivering, via the braille cells, the user-inputted form to the braille display for preview. In a related embodiment, the method further comprises the steps of converting the authenticated form in braille to text, and delivering the converted form to a bank teller for the processing thereof.

In another embodiment, the input and output means comprise at least one speaker for voice-delivering the user-selected form one query at a time and a microphone for receiving the user's voice as input as a response to each query. In a related embodiment, the method further comprises voice-delivering the user-inputted form from the at least one speaker for preview. In a related embodiment, the method further comprises delivering the authenticated form to a bank teller for the processing thereof. In one embodiment, the method further comprises storing the plurality of forms within a database, and receiving the user's selection of a form from the database. In another embodiment, the authentication comprises a fingerprint of the user.

Another aspect of the present disclosure is directed to a computer-implemented banking system for the visually-challenged, the system comprising: (a) an electronic refreshable braille display comprising a plurality of dynamic braille cells for displaying a user-selected form one query at a time, and a braille keyboard for enabling a user to deliver input as a response to each query; (b) a preview module for delivering the user-inputted form to the braille display for preview; and (c) an authentication module for receiving the user's authentication upon the user finalizing the previewed form, the authentication associated with the form. In a related embodiment, the system further comprises a database comprising the plurality of forms stored therewithin; a form selected by the user from the database via the braille terminal.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1, according to an embodiment of the present invention, is a block diagram of the computer-implemented system.

FIG. 2, according to an embodiment of the present invention, is a flowchart of the computer-implemented method.

### DETAILED DESCRIPTION OF EMBODIMENTS

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The invention disclosed herein generally relates to a computer-implemented banking system and method for assisting customers and more particularly to a system and a method for visually-challenged customers.

Embodiments of the present invention are directed to a computer-implemented system and method for enabling the visually-challenged to perform banking operations without human assistance. More particularly, said banking operations include filling out banking forms (which include various application forms and contracts), authenticating the filled out forms and delivering the authenticated forms to a bank teller for subsequent processing thereof.

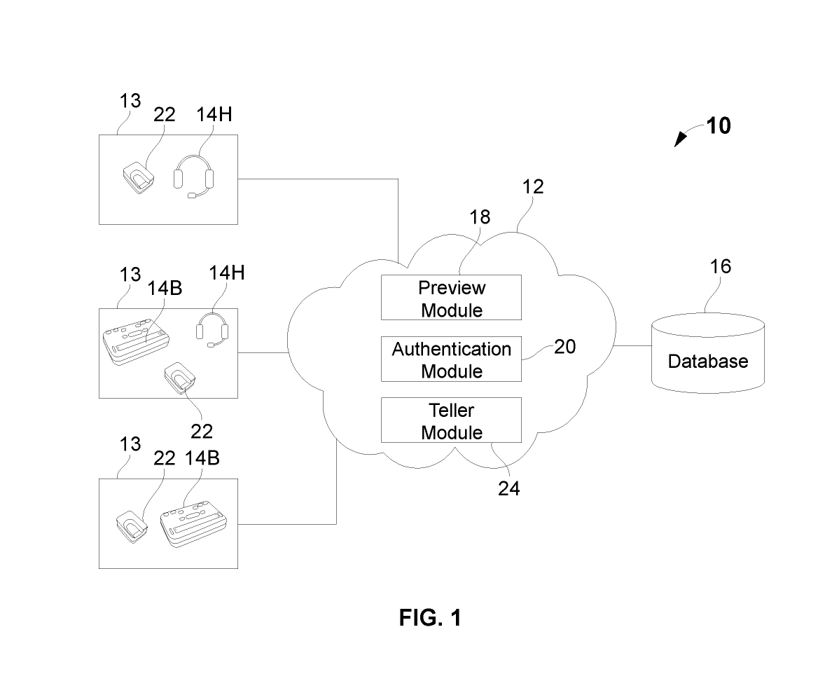

Referring to FIG. 1, the system 10 of the present invention comprises a remote server 12 and various user terminals 13 disposed in operative communication with the server 12 over a communications network such as, a cellular network, Bluetooth, a Local Area Network, the Internet, etc. A user terminal 13, about which a visually-challenged user interacts with the server 12, comprises a two or more client devices that are grouped together so as to work in tandem with one another. The client devices are divided into communication and authentication devices. A communication device may comprise an electronic refreshable braille display 14B or a headset 14H with a microphone. The authentication device comprises a fingerprint scanner 22. Alternatively, the authentication device may comprise a facial recognition sensor, a digital signature storage, a retinal scanner, etc. The system 10 further includes at least one memory (not shown) for storing instructions, which are executed by at least one processor (not shown).

Referring to FIG. 1, the system 10 further comprises a database 16 comprising a plurality of banking forms stored therewithin. On a side note, the database 16 may be co-located with the server 12 or may be remotely disposed with respect to the server 12. The system 10 further comprises a plurality of processing modules comprising a menu module (not shown), a preview module 18, an authentication module 20 and a teller module 24 wherein, each of said modules will become apparent from the following body of text.

Referring to FIG. 1, the menu module (not shown) is configured to deliver a menu to the communication device, where the user is made aware of the forms he/she is entitled to access. More particularly, in the event of the communication device comprising a braille display 14B, the titles of the forms are delivered to the output means of the braille display 14B in order for them to be read by the user. Upon reading, the user, via an input means, is enabled to select a form from the menu. On a side note, the input and output means comprise the braille keyboard and the dynamic braille cells respectively disposed on the braille display 14B.

Referring to FIG. 1, in response to the user-selection of a form, the selected form is delivered to the braille display 14B, one query at a time. For example, a query may comprise a query soliciting the bank account number of the user. In response to the query, the user, via the braille keyboard, is enabled to input a response to each query. On a side note, an input to a query could be a simple “skip” when said query is not applicable to the user. A next query is delivered to the braille display 14B upon the completion of the user-input to the preceding query.

Referring to FIG. 1, the preview module 18, for user-preview purposes, is configured to deliver the completed form to the braille display 14B one query and the corresponding input at a time. In one embodiment, the preview is provided on a braille paper, which is generated by a braille printer. The braille paper may comprise either projecting/embossed dots or perforated dots for enabling a user to discern braille text. The authentication module 20, upon receiving an indication (via the braille keyboard) indicating user satisfaction with the completed form, is configured to receive an authentication from the user in the form of a user's fingerprint via the fingerprint scanner 22, at which point the form is deemed authentic. The authentic form is delivered to a bank teller as enabled by the teller module 24. More particularly, the teller module 24 comprises a conversion module (not shown) for converting the authentic form in braille to text for the bank teller to perceive. On a side note, the conversion module is configured such that, upon conversion, the converted form still retains the user fingerprint. The teller module 24 further comprises a delivery module (not shown) for delivering the converted form to the bank teller for the subsequent processing thereof.

Referring to FIG. 1, on the other hand, in the event of the communication device comprising a headset 14H, the menu module (not shown) is configured to voice-deliver the titles of the forms to the user via the at least one speaker of the headset 14H. Upon learning of the available forms, the user, via the microphone, is enabled to select a form from the menu by means of a preset voice command. In response to the user-selection of a form, the selected form is again voice-delivered to the headset 14H, one query at a time. For example, a query may comprise the bank account number of the user. In response to the query, the user, via the microphone, is enabled to voice-input a response to each query. On a side note, an input to a query could be a simple vocal “skip” when said query is not application to the user. A next query is voice-delivered to the user upon his/her completion of the input to the preceding query.

Referring to FIG. 1, again, in the event of the communication device comprising a headset 14H, the preview module 18, is configured to voice-deliver the completed form to the user one query and the corresponding input at a time. The authentication module 20 is, upon receiving an indication (by a preset voice-command) indicating user's satisfaction with the completed form, configured to receive an authentication from the user in the form of a user's fingerprint via the fingerprint scanner 22, at which point the form is deemed authentic. The authentic form is delivered to a bank teller as enabled by the teller module 24.

In one embodiment, the user terminal 13, as seen in FIG. 1, may employ both the communication devices in order for the user to interact with the server 12. For example, a query may be delivered to the braille display 14B and the input thereto is delivered by the user via the headset 14H or vice versa.

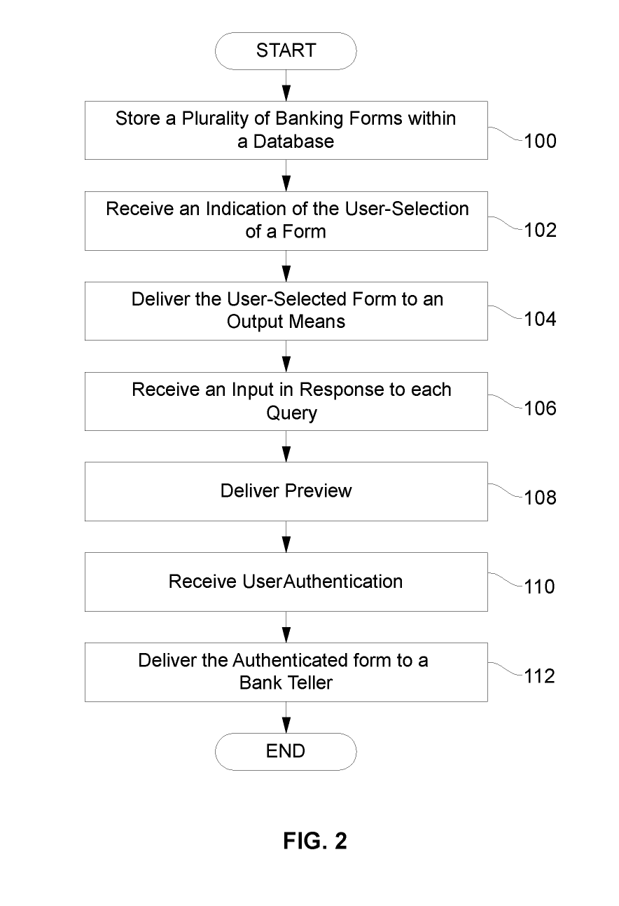

Referring to FIG. 2, the method of the present invention initiates with a plurality of banking forms being stored (step 100) within a database. The method further includes delivering a menu to a user terminal, where the user is made aware of the forms he/she is entitled to access. The user terminal is disposed in operative communication with a remote server over a communications network such as, a cellular network, Bluetooth, a Local Area Network, the Internet, etc. A user terminal, about which a visually-challenged user interacts with the server, comprises a two or more client devices that are grouped together so as to work in tandem with one another.

The client devices are divided into communication and authentication devices. A communication device may comprise a braille display or a headset with a microphone. The authentication device comprises a fingerprint scanner. Alternatively, the authentication device may comprise a facial recognition sensor, a digital signature storage, a retinal scanner, etc. On a side note, the database may be co-located with the server or may be remotely disposed with respect to the server.

More particularly, in the event of the communication device comprising a braille display, the menu, comprising the titles of the forms, is delivered to the output means of the braille display in order for them to be read by the user. Upon reading the menu, the user, via an input means, is enabled to select a form therefrom. On a side note, the input and output means comprise the braille keyboard and the braille display cells respectively disposed on the braille display.

Referring to FIG. 2, the method further includes receiving (step 102), via the braille display, i.e., via the braille keyboard more particularly, the indication of the user-selection of a form from the menu. The method further includes, in response to the indication of said user-selection, delivering (step 104) the user-selected form to the braille display, one query at a time. For example, a query may comprise the query soliciting bank account number of the user. The method further includes, in response to the query, receiving (step 106) an input via the braille keyboard. On a side note, an input to a query could be a simple “skip” when said query is not application to the user. A next query is delivered to the braille display upon the completion of the user-input to the preceding query.

Referring to FIG. 2, the method further includes delivering a preview (step 108) of the completed form to the braille display one query and the corresponding input at a time. The braille paper may comprise either projecting/embossed dots or perforated dots for enabling a user to discern braille text. Upon finalizing the previewed form (by means of the braille keyboard), the method further includes receiving an authentication from the user (step 110) in the form of a user's fingerprint via the fingerprint scanner, at which point the form is deemed authentic. The method finally includes delivering (step 112) the authentic form to a bank teller. The final step of the method includes converting the authentic form in braille to text for the bank teller to perceive. On a side note, upon conversion, the converted form still retains the user fingerprint. The final step of the method further includes delivering the converted form to the bank teller for the subsequent processing thereof.

On the other hand, in the event of the communication device comprising the headset, the menu, comprising the titles of the forms, is voice-delivered to the at least one speaker of the headset in order for them to be learnt by the user. Upon learning, the user, via the microphone, is enabled to select a form therefrom by means of issuing a preset voice-command.

Referring to FIG. 2, the method further includes receiving (step 102), via the headset, i.e., via microphone more particularly, the indication of the user-selection of a form from the menu by a preset voice-command. The method further includes, in response to the indication of said user-selection, voice-delivering (step 104) the user-selected form to the headset, one query at a time. For example, a query may comprise the query soliciting bank account number of the user. The method further includes, in response to the query, receiving (step 106) an input via the microphone. On a side note, an input to a query could be a simple vocal “skip” when said query is not applicable to the user. A next query is voice-delivered to the headset upon the completion of the user-input to the preceding query.

Referring to FIG. 2, the method further includes voice-delivering a preview (step 108) of the completed form to the headset one query and the corresponding input at a time. Upon finalizing the previewed form (by means of issuing a preset voice-command), the method further includes receiving an authentication from the user (step 110) in the form of a user's fingerprint via the fingerprint scanner, at which point the form is deemed authentic. The method finally includes delivering (step 112) the authentic form to a bank teller.

One aspect of the present disclosure is directed to a computer-implemented banking system for the visually-challenged. The system comprising a user terminal comprising an output means for perceivably-delivering to a user, a user-selected form from a plurality of banking forms, the form delivered one query at a time; and an input means for receiving user input as a response to each query. The system further comprises a preview module for perceivably-delivering the user-inputted form to the output means for preview; and an authentication module for receiving the user's authentication upon the user finalizing the previewed form, the authentication associated with the form.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A computer-implemented banking system for the visually-challenged, the system comprising:
(a) a user terminal comprising:
(i) an output means for perceivably-delivering to a user, a user-selected form from a plurality of banking forms, the form delivered one query at a time, and
(ii) an input means for receiving user input as a response to each query,
(b) a preview module for perceivably-delivering the user-inputted form to the output means for preview, and
(c) an authentication module for receiving the user's authentication upon the user finalizing the previewed form, the authentication associated with the form.

2. The system of claim 1, wherein the user terminal comprises an electronic refreshable braille display and wherein, the input and output means comprise a plurality of dynamic braille cells and a braille keyboard respectively.

3. The system of claim 2, wherein the user-inputted form is delivered to the braille display for preview.

4. The system of claim 2, further comprising a teller module for converting the authenticated form in braille to text; the converted form delivered to a bank teller for the processing thereof.

5. The system of claim 1, wherein the user terminal comprises a headset with microphone and wherein, the input and output means comprise at least one speaker for voice-delivering the user-selected form one query at a time and a microphone for receiving the user's voice as input as a response to each query.

6. The system of claim 5, wherein the user-inputted form is voice-delivered from the at least one speaker for preview.

7. The system of claim 5, further comprising a teller module for delivering the authenticated form to a bank teller for the processing thereof.

8. The system of claim 1, further comprising a database comprising the plurality of forms stored therewithin; a form selected by the user from the database via the user terminal.

9. The system of claim 1, wherein the authentication module comprises a fingerprint scanner and wherein the authentication comprises a fingerprint of the user.

10. A computer-implemented method for assisting the visually-challenged in banking operations, the method comprising the steps of:
(a) perceivably-delivering to a user, via an output means, a user-selected form from a plurality of banking forms, the form delivered one query at a time,
(b) receiving user input, via an input means, in response to each query,
(c) perceivably-delivering the user-inputted form, via the output means, to the user for preview, and
(d) receiving the user's authentication upon finalization.

11. The method of claim 10, wherein the input and output means comprise a plurality of refreshable braille cells and a braille keyboard respectively.

12. The method of claim 11, further comprising delivering, via the braille cells, the user-inputted form to the braille display for preview.

13. The method of claim 11, further comprising the steps of:
(a) converting the authenticated form in braille to text, and
(b) delivering the converted form to a bank teller for the processing thereof.

14. The method of claim 10, wherein the input and output means comprise at least one speaker for voice-delivering the user-selected form one query at a time and a microphone for receiving the user's voice as input as a response to each query.

15. The method of claim 14, further comprising voice-delivering the user-inputted form from the at least one speaker for preview.

16. The method of claim 14, further comprising delivering the authenticated form to a bank teller for the processing thereof.

17. The method of claim 10, further comprising the steps of:
(a) storing the plurality of forms within a database, and
(b) receiving the user's selection of a form from the database.

18. The method of claim 10, wherein the authentication comprises a fingerprint of the user.

19. A computer-implemented banking system for the visually-challenged, the system comprising:
(a) an electronic refreshable braille display comprising:
(i) a plurality of dynamic braille cells for displaying a user-selected form one query at a time, and
(ii) a braille keyboard for enabling a user to deliver input as a response to each query,
(b) a preview module for delivering the user-inputted form to the braille display for preview, and
(c) an authentication module for receiving the user's authentication upon the user finalizing the previewed form, the authentication associated with the form.

20. The system of claim 19, further comprising a database comprising the plurality of forms stored therewithin; a form selected by the user from the database via the braille terminal.
